(19) United States
(12) Patent Application Publication
(10) Pub. No.: US 2012/0235007 A1
(43) Pub. Date: Sep. 20, 2012

(54) LOCKING DEVICE, SEAT MOVING DEVICE, VEHICLE SEAT, MOTOR VEHICLE, AND METHOD THEREFOR

(75) Inventor: Andrzej PLESKOT, Trebur (DE)

(73) Assignee: GM GLOBAL TECHNOLOGY OPERATIONS LLC, Detroit, MI (US)

(21) Appl. No.: 13/421,956

(22) Filed: Mar. 16, 2012

(30) Foreign Application Priority Data
Mar. 18, 2011 (DE) 10 2011 014 333.5

(51) Int. Cl. B60N 2/08

(52) U.S. Cl. 248/429

(57) ABSTRACT

A locking device is provided for locking and/or releasing a longitudinal movement of a seat, in particular a vehicle seat, which includes, but is not limited to at least one unlocking device for locking or unlocking the seat, and at least one actuating unit, which is operationally linked to the at least one unlocking device, and at least one blocking device provided for blocking the longitudinal movement.

### CROSS-REFERENCE TO RELATED APPLICATION

This application claims priority to German Patent Application No. 10 2011 014 333.5, filed Mar. 18, 2011, which is incorporated herein by reference in its entirety.

### TECHNICAL FIELD

The technical field relates to a locking device for locking and/or releasing a longitudinal movement of a seat, in particular a vehicle seat, comprising at least one unlocking device for locking or unlocking the seat, and at least one actuating unit, which is operationally linked to the at least one unlocking device. Furthermore, the technical field relates to a seat moving device for moving a seat in the longitudinal direction, in particular a vehicle seat in a motor vehicle, having a lock for locking and/or releasing a longitudinal movement of a seat. In addition, the technical field also relates to a vehicle seat having a moving system for moving the vehicle seat and the longitudinal direction, a motor vehicle having at least one vehicle seat device, and a method for handling a seat, in particular a vehicle seat of a motor vehicle, in which the seat is movable in the longitudinal direction after unlocking.

### BACKGROUND

Moving devices for seats, in particular for vehicle seats, are generally known. The adjustment of the seats in the longitudinal direction, i.e., in the viewing direction of a person sitting on the seat, is triggered by with an actuating unit. Locking systems are known for locking the seat in a specific position. However, the actuating unit and the locking system are not secured against unintentional triggering of the seat adjustment, for example, during installation of the seat.

WO 02/14102 A1 describes a longitudinal adjustment device for motor vehicle seats, in which the seat is fastened on each seat longitudinal side on slide rails, which are displaceably arranged in vehicle-fixed guide rails. Each slide rail has a locking device, which can be disengaged from the connection with the guide rail, and which comprises an unlocking lever pivotably supported on each slide rail for the transfer into a release location, the lever being adjusted via spars of an actuating element mounted on the slide rails. The transmission of a positioning torque exerted on the actuating element to the spars occurs via a compensation gear with decoupling of the spars from one another. In this way, each spar can be moved into the release location up to the final transfer of the locking device. The locking device prevents displacement of the vehicle seat in the longitudinal direction through an engagement in the slide rail. Separate securing or blocking of the movement is not provided in this case.

It is therefore at least one object to provide a locking device and a seat moving device for a seat, in which unintentional movement of the seat can be prevented by blocking of the seat movement. In particular, it is at least one object invention to provide a vehicle seat and a motor vehicle therefor, as well as a method for the longitudinal movement of a seat. In addition, other objects, desirable features, and characteristics will become apparent from the subsequent summary and detailed description, and the appended claims, taken in conjunction with the accompanying drawings and this background.

### SUMMARY

A locking device is provided for locking and/or releasing a longitudinal movement of a seat, in particular a vehicle seat, comprising at least one unlocking device for locking or unlocking the seat, and at least one actuating unit, which is operationally linked to the at least one unlocking device, it is provided that at least one blocking device is provided for blocking the longitudinal movement, in particular independently of an actuation of the unlocking device and/or the actuating unit. A longitudinal movement is understood as a movement of the seat in the viewing direction of a person seated on the seat, i.e., forward and/or backward. The longitudinal movement therefore preferably occurs in a vehicle longitudinal direction, at least in the case of a driver's seat. Other movement directions are also implementable in the case of other seats.

The unlocking device is implemented in one piece in one embodiment. In another embodiment, the unlocking device is implemented in multiple parts, in particular two or three parts. For example, the unlocking device is implemented in the form of a pin or clamp. The unlocking device fixes the seat in a specific longitudinal position. For this purpose, the unlocking device preferably engages in a rail system, via which the seat is movable. Upon unblocking of the unlocking device, the seat is movable in the longitudinal direction. Upon blocking, the seat is not movable in the longitudinal direction.

The actuating unit is implemented either in one piece or multiple parts. The actuating unit is advantageously implemented in multiple parts, in particular two or three parts. For example, the actuating unit is implemented as a lever or crank. The actuating unit is advantageously operationally linked to the unlocking unit. For example, multiple unlocking units can be actuated simultaneously and/or jointly via the actuating unit. The unlocking device is unlockable or blockable with the actuating unit, so that a movement of the seat is made possible or prevented. The blocking device is implemented in such a manner that it prevents unlocking independently of the actuation of the actuating unit. In other words, the blocking device functions as a switch, which turns on and off the function of the unlocking device and/or the actuating unit. In this way, it is possible, for example, in the event of an installation and/or removal of a vehicle seat having unlocking device, to block the unlocking device, so that accidents do not occur here because of an unintentional actuation of the unlocking device.

In one embodiment, it is provided that the at least one blocking device is coupled to the at least one actuating unit and/or the at least one unlocking device for the blocking. The blocking device is advantageously coupled or operationally linked to the actuating unit. In one embodiment, the blocking device and the actuating unit are implemented integrally. In other embodiments, the blocking device and the actuating unit are implemented separately and are operationally linked to one another and are therefore implemented in multiple parts. In another embodiment, the blocking device is coupled or operationally linked to the unlocking device. In one embodiment, the blocking device and the unlocking device are implemented integrally. In other embodiments, the blocking device and the unlocking device are implemented separately and are operationally linked to one another and are therefore implemented in multiple parts. In still another embodiment, the blocking device is operationally linked to the actuating unit and the unlocking device. The actuating unit and the unlocking device are advantageously coupled to one another and therefore operationally linked.

The coupling is implemented indirectly via the blocking device in the embodiment. By switching the blocking device, the operational link between actuating unit and unlocking device can therefore be canceled or coupled. Therefore, the operational link can be canceled or implemented by switching the blocking device. By means of the blocking device, the respective component connected to the blocking device is blockable or unblockable in its function, independently of its actuation. Therefore, the longitudinal movement of the seat can finally be prevented or executed by the blocking unit, and the seat is lockable in its respective longitudinal position.

In another embodiment, it is provided that the at least one blocking device comprises a blocking element, which is mounted so it is movable between at least one blocking position and at least one release position. The movement of the blocking element is implemented in one embodiment as a translational movement, in another embodiment as a rotational movement, and in still another embodiment as both a translational movement and a rotational movement. Therefore, the blocking element has a degree of movement freedom from one degree of freedom up to six degrees of freedom (three translation degrees of freedom and three rotational degrees of freedom) depending on the respective embodiment. Alternatively, the blocking element is also implemented as telescoping and/or changeable in its shape. The various types of movement are arbitrarily combinable with one another. The blocking element is implemented in one piece in a preferred embodiment. In another embodiment, the blocking element is implemented in multiple parts, in particular two or three parts. For example, the blocking element is implemented as a block. If the blocking element is located in a release position, the longitudinal movement of the seat is possible through actuation of the actuating unit and therefore unlocking of the unlocking device. As soon as the blocking element is located in a blocking position, however, the longitudinal movement of the seat is blocked.

In one embodiment, it is provided that the blocking element is implemented as mounted so it is movable in the direction of the longitudinal movement of the seat. In still another embodiment, it is provided that the blocking element is implemented as mounted so it is movable transversely to the longitudinal movement of the seat. The movement of the blocking element in the movement direction of the seat preferably occurs in a translational and/or rotational manner, alternatively, a telescoping movement occurs. The blocking element is advantageously mounted so it is rotatable around a rotational axis, and otherwise is fixed in place, for the movable mounting.

The rotational axis is arranged transversely or longitudinally to the direction of the longitudinal movement of the seat in accordance with the movement direction of the blocking element relative to the movement direction of the seat. The mounting of the blocking element is, for example, as a radial bearing, friction bearing, ball bearing, roller bearing, and/or rail.

In a further embodiment, at least one fixing unit is provided, in order to lock the blocking element in the blocking position and/or the release position. In one embodiment, the fixing unit is arranged directly on the blocking device and/or the blocking element or integrated therein, i.e., implemented in one piece. By means of the fixing unit, unintentional rotation of the blocking unit between a release position and a blocking position or disengagement of the blocking unit from its respective position is avoidable. The fixing unit is also, for example, implemented on the actuating unit or on a vehicle-side component, for example, a rail guide for the seat. The fixing unit is implemented in one piece in one embodiment, for example, as a clamp. In another embodiment, the fixing unit is implemented in multiple parts, in particular two or three parts. For example, one part of the fixing unit is implemented on the blocking unit and another part on the actuating unit.

A tool-triggered rotation of the blocking unit is advantageously possible. In particular, it is advantageous to rotate the blocking element from the blocking position into the release position in a tool-triggered manner The blocking element has an engagement point for this purpose. In one embodiment, the engagement point is implemented on the mount of the blocking element, for example, as a square screw head or hexagonal socket. In another embodiment, the engagement point is implemented on one side of the blocking element.

Furthermore, a seat moving device is provided for moving a seat in a longitudinal direction, in particular a vehicle seat in a motor vehicle, having a lock for locking and/or releasing a longitudinal movement of the seat, it is provided that the seat moving device is implemented in one embodiment as described above. In one embodiment, the seat moving device comprises at least one seat-side rail unit, which can slide relatively along at least one vehicle-side complementary rail unit. The relative sliding movement of the rail units to one another is blockable and unblockable with the locking device, so that a movement is prevented or allowed. For this purpose, for example, an engagement in a corresponding opening of the rail units occurs, so that they are immovable relative to one another.

A longitudinal movement of the seat can be executed with the actuating unit through a disengagement of the unlocking device. The seat then slides over the seat-slide rail unit relative to the vehicle-side complementary rail unit. The rail units are arranged in the longitudinal direction of the seat, so that a movement in the longitudinal direction is possible. Other orientations are also implementable. The longitudinal movement is advantageously only possible when the blocking element is oriented in the release position. The blocking element therefore allows unblocking of the unlocking device by the actuating unit. When the actuating unit is released, the unlocking device fixes the seat in its respective position on the rail units, in that the sliding is blocked, even if the blocking element is located in the release position. This is performed by blocking, for example, i.e., by engagement of the unlocking unit in the rail units which can slide relative to one another. If the blocking element is rotated into the blocking position, unblocking of the unlocking device by the actuating unit is prevented, so that the seat is fixed in its respective position, i.e., is not longitudinally movable. In another embodiment, the blocking element blocks the movement of the seat by blocking of the unlocking device. Sliding of the rail units against one another is thus prevented.

A vehicle seat is provided that has a movement system for moving the vehicle seat in the longitudinal direction, it is provided that the movement system is implemented in one embodiment as the above-described seat moving device. In the case of a vehicle seat having the above-described seat moving device, the fixing of the seat in a specific position is executable independently of an actuation of the actuating unit. The vehicle seats are individual seats or bench seats, for example. A vehicle seat is advantageously mounted so it can slide on both longitudinal sides in each case on a pair of two complementary rail units. In one embodiment, the locking device is implemented on one side, i.e., only on one rail unit pair, in another embodiment, it is implemented on both sides. In a preferred embodiment, a blocking element is only implemented on one rail unit pair. Therefore, a longitudinal movement of the vehicle seat on the rail units advantageously occurs synchronously, i.e., the movement occurs uniformly on the rail units on both longitudinal sides of the vehicle seat.

In addition, a motor vehicle is provided that has at least one vehicle seat device, it is provided that the at least one vehicle seat device is implemented in one embodiment as the above-described vehicle seat. The vehicle can be, for example, a motor vehicle such as a sedan, jeep, caravan, SUV, or omnibus, or a rail vehicle such as a passenger train. The longitudinal direction of the seat movement relative to the vehicle is dependent on the orientation of the vehicle seat. In one embodiment, the vehicle seat is oriented having the viewing direction of the passenger in the direction of the longitudinal axis of the vehicle, the direction of the longitudinal movement then nearly corresponds to the longitudinal axis of the vehicle. In another embodiment, if the vehicle seat is installed having viewing direction transverse to the longitudinal axis of the vehicle, the longitudinal movement of the seat is also transverse to the vehicle longitudinal axis. Curved directions along a curved rail guide are also implementable, for example.

A method for handling a seat, in particular a vehicle seat of a motor vehicle, in which the seat is movable in the longitudinal direction after unlocking, at least the step of blocking the movement of the seat in order to lock the vehicle seat in a position is provided. The method is advantageously executable during the installation and/or removal of a seat. It is ensured by means of the method having locking that the seat is arranged in the same position on the seat rails on both longitudinal sides during the installation and/or removal. By means of the blocking element, unintended and uneven movement of the seat is prevented, so that the movement of the seat advantageously occurs synchronously. Irregularities in the seat setting are therefore possibly not immediately noticeable and are only conspicuous to a customer upon use. An extensive description of the method during the installation of the seat is performed in the description of the figures.

In another embodiment, the method is also applicable in the case of an already installed seat. The blocking unit is also controllable via a radio signal or electronically, for example. A coupling to a door key or the actuation of the ignition key is thus implemented, for example.

Further measures that improve the embodiments are also provided or result from the following description of exemplary embodiments, which are schematically shown in the figures. Uniform reference signs are used for identical or similar components or features. Features or components of various embodiments can be combined with one another to thus obtain further embodiments. All features and/or advantages from the claims, the description, or the drawings, including design details, spatial arrangement, and method steps, may thus be essential to the invention per se and also in greatly varying combinations.

### BRIEF DESCRIPTION OF THE DRAWINGS

The present invention will hereinafter be described in conjunction with the following drawing figures, wherein like numerals denote like elements, and:

FIG. 1 shows a schematic perspective view of a seat moving device having a locking device;

FIG. 2 shows an enlarged detail in partial section of the schematic perspective view of the seat moving device having the locking device according to FIG. 1;

FIG. 3 shows a further enlarged detail of the schematic perspective view of the seat moving device having the locking device according to FIG. 1;

FIG. 4 shows a schematic perspective view of a blocking element;

FIG. 5 shows a schematic sectional partial view of the seat moving device having the locking device in a release position;

FIG. 6 shows a schematic sectional partial view of the seat moving device having the locking device according to FIG. 5 in an intermediate position;

FIG. 7 shows a schematic sectional partial view of the seat moving device having the locking device according to FIG. 5 in a blocking position;

FIG. 8 shows a schematic side view of the seat moving device having the locking device in a blocking position;

FIG. 9 shows a schematic side view of the seat moving device having the locking device according to FIG. 8 in a release position;

FIG. 10 shows a further schematic side view of the seat moving device having the locking device according to FIG. 8 in a release position;

FIG. 11 shows a schematic side view of a vehicle seat having the seat moving device having the locking device;

FIG. 12 shows a schematic side view and top view of the seat moving device having the locking device in a blocking position in a first installation position;

FIG. 13 shows a schematic side view and top view of the seat moving device having the locking device according to FIG. 12 in a release position in the first installation position;

FIG. 14 shows a further schematic side view and top view of the seat moving device having the locking device according to FIG. 12 in the release position in the first installation position;

FIG. 15 shows a schematic side view and top view of the seat moving device having the locking device according to FIG. 12 in the release position in a second installation position;

FIG. 16 shows a schematic perspective partial view of the seat moving device having the locking device according to FIG. 1 in a blocking position and an auxiliary means;

FIG. 17 shows a schematic perspective partial view of the seat moving device having the locking device according to FIG. 1 in an intermediate position and the auxiliary means;

FIG. 18 shows a schematic perspective partial view of the seat moving device having the locking device according to FIG. 1 in a release position and the auxiliary means, and

FIG. 19 shows a further schematic perspective partial view of the seat moving device having the locking device according to FIG. 1 in a release position and the auxiliary means.

### DETAILED DESCRIPTION

The following detailed description is merely exemplary in nature and is not intended to limit application and uses. Furthermore, there is no intention to be bound by any theory presented in the preceding background or summary or the following detailed description.

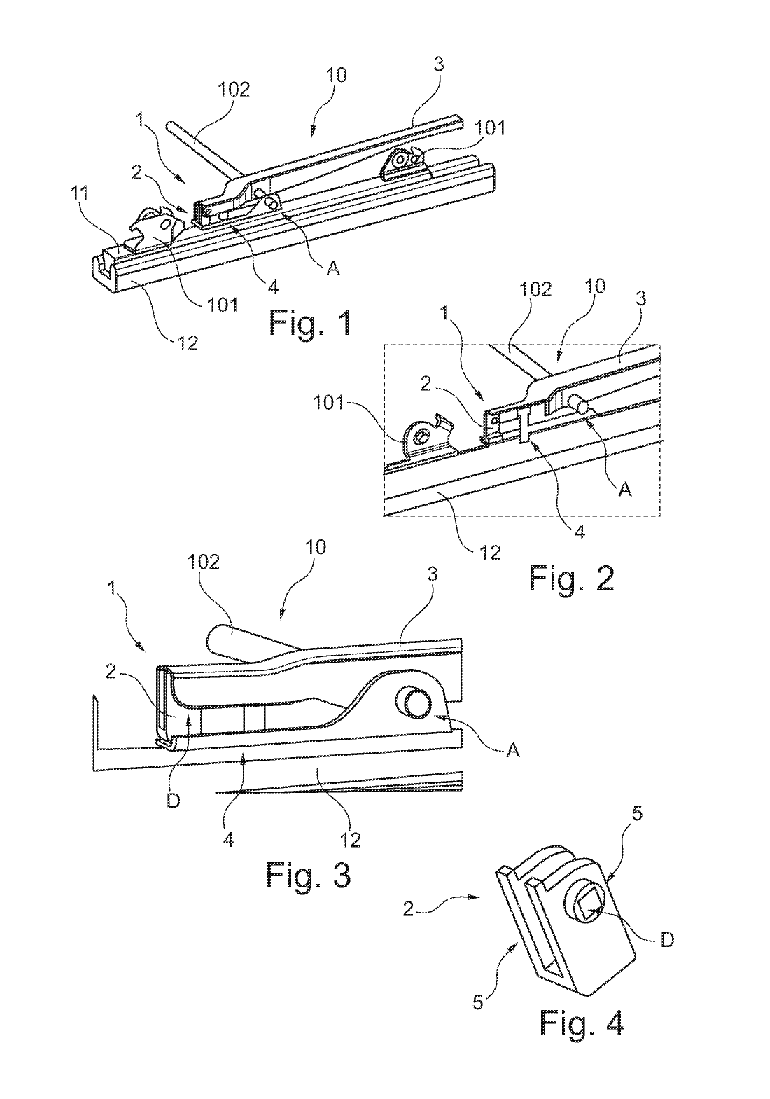

FIG. 1 shows a schematic perspective view of a seat moving device 10 having a locking device 1 of a vehicle seat (not shown for clarity). The seat moving device 10 comprises a seat-side rail unit 11 and a complementary vehicle-side rail unit 12 on each longitudinal side of the vehicle seat, only one side being shown. The vehicle seat is fastened in each case to the seat-side rail unit 11 on the seat fasteners 101. The vehicle seat is mounted so it can slide in the longitudinal direction on the rail units 11 and 12.

The locking device 1 comprises one actuation unit 3 per rail unit 11 or 12. The actuating units 3 are connected by means of a transverse strut 102 for stabilization and for the operational linkage, since the locking device 1 is only implemented on one side of the vehicle seat. Furthermore, the locking device 1 comprises an unlocking device 4. The actuating unit 3 and the unlocking device 4 are operationally linked, i.e., through an actuation of the actuating unit 3, the unlocking device 4 unblocks or blocks the sliding of the rail units 11 and 12 against one another. The locking device 1 further comprises a blocking device implemented as a blocking element 2. The blocking element 2 is mounted so it is rotatable on the actuating unit 3. In FIG. 1, the blocking element 2 is shown in a blocking position, unblocking of the unlocking device 4 via the actuating unit 3 being prevented by the blocking element 2. The actuating unit 3 is implemented like a rocker. Upon raising of the lever section of the actuating unit 3 facing away from the unlocking device 4 and, in conjunction therewith, rotation or pivoting of the lever section around a transversely extending axis A, the unlocking device 4 is actuated, i.e., pressed downward, by a second lever section of the unlocking device 4, which is pressed downward with the rotation. If the blocking element 2 is in the blocking position as in FIG. 1, the pressing down of the unlocking device is prevented. The unlocking device 4 comprises a pin-shaped unlocking element, which, to block the rail units 11 and 12, which can slide against one another, engages therein. The axis A of the actuating unit 3 is formed in this embodiment by the transverse strut 102. Accordingly, the unlocking devices 4 of the rail units 11 and 12 on both sides of the seat are coupled to one another by the transverse strut 102, so that both sides can be unblocked and released by means of one actuating unit 3.

FIG. 2 and FIG. 3 each show an enlarged or further enlarged, respectively, detail in partial section of the schematic perspective view of the seat moving device 10 having the locking device 1 according to FIG. 1. In FIG. 2, above all the unlocking device 4, which is implemented as the pin-shaped unlocking element, can be recognized. The blocking element 2 is mounted so it is rotatable around the rotational axis D of a rotational mount.

FIG. 4 shows a schematic perspective view of a blocking element 2. The blocking element 2 is implemented in one piece as a U-shaped block. The rotational mount having the rotational axis D is implemented on the ends of the legs of the U-shaped block. Furthermore, lug-shaped extensions are implemented on the ends of the legs, in order to achieve additional stabilization of the blocking element 2 in the blocking position on the actuating unit 3. The legs are connected to one another by means of an intermediate web. The blocking element 2 has two engagement points 5, on the one hand, on the rotational axis D of the rotational mount, which is implemented as a square, and, on the other hand, on the legs.

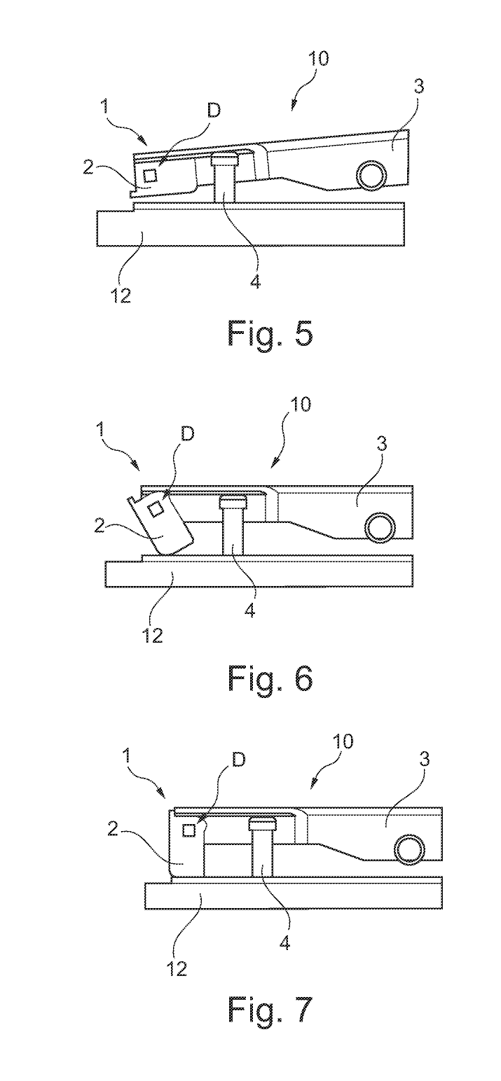

FIG. 5 to FIG. 7 each show a schematic sectional partial view of the seat moving device 10 having the locking device 1, the actuating unit 3 and the blocking element 2 being shown in various positions, namely release and blocking positions and intermediate position. The individual components of the locking device 1 correspond to the components shown in FIG. 1. An explanation of already described components will therefore be omitted. In FIG. 5, the blocking element 2 is shown in a release position, so that pivoting of the actuating unit 3 is possible, to cause unblocking of a longitudinal movement of the seat. The blocking element 2 presses against the actuating unit 3 nearly parallel thereto. Upon rotation of the actuating unit 3 around the axis A, the unlocking device 4 is moved in the direction of rail units 11 and 12 and therefore unblocked. The blocking element 2 is secured in the release position by means of fixing units, so that it does not unintentionally rotate into the blocking position. The fixing units (not shown here) are implemented as a clamp, the fixing units on the actuating unit 3 being clamped against the blocking element 2 and thus producing a press fit. In FIG. 6, the actuating unit 3 is shown in its starting position, i.e., actuated. The blocking element 2 is rotated out of the release position in the direction of the blocking position. The rotation occurs around the rotational axis D of the rotational mount. In FIG. 7, the blocking element 2 is rotated completely into the blocking position. It therefore prevents unblocking of the unlocking device 4, in that it prevents pivoting of the actuating unit 3.

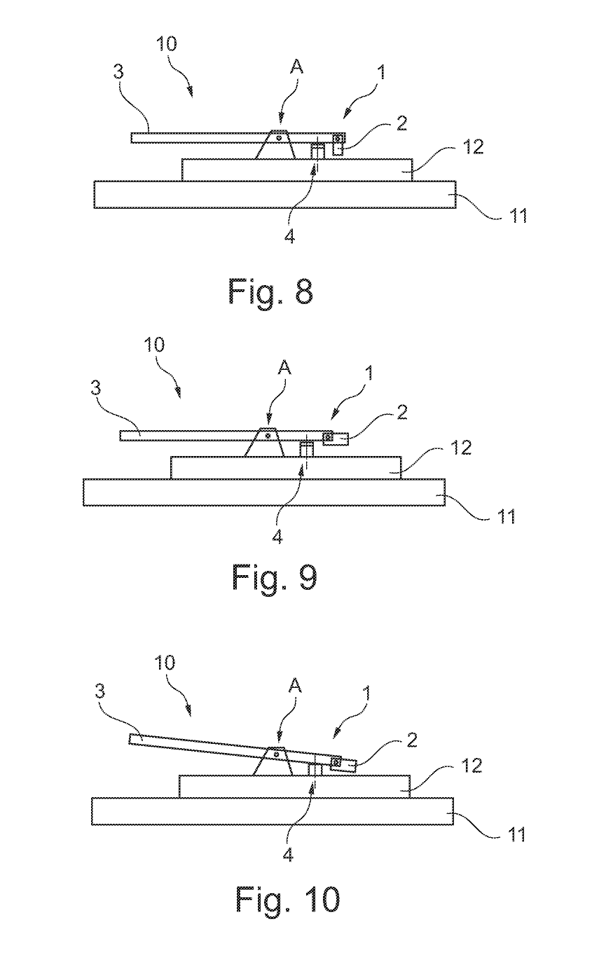

FIG. 8 to FIG. 10 each show a schematic side view of the seat moving device 10 having the locking device 1, the actuating unit 3, the blocking element 2, and the unlocking element of the unlocking device 4 being shown in various positions. The individual components of the locking device 1 correspond to the components shown in FIG. 1. An explanation of already described components will therefore be omitted. In FIG. 8, the blocking element 2 is shown in the blocking position (see also FIG. 7). In FIG. 9, the blocking element 2 is shown in a release position (see also FIG. 5), the release position of FIG. 5 differing from that shown in FIG. 9 in the orientation of the blocking element 2. According to FIG. 5, the blocking element 2 is rotated below the actuating unit 3, and in FIG. 9, the blocking element 2 is rotated to an “extension” of the actuating unit 3 and therefore protrudes beyond it. In FIG. 10, the blocking element 2 is shown in a release position having pivoted actuating unit 3, so that pivoting of the actuating unit 3 is executed, in order to cause unblocking of a longitudinal movement of the seat (see FIG. 5).

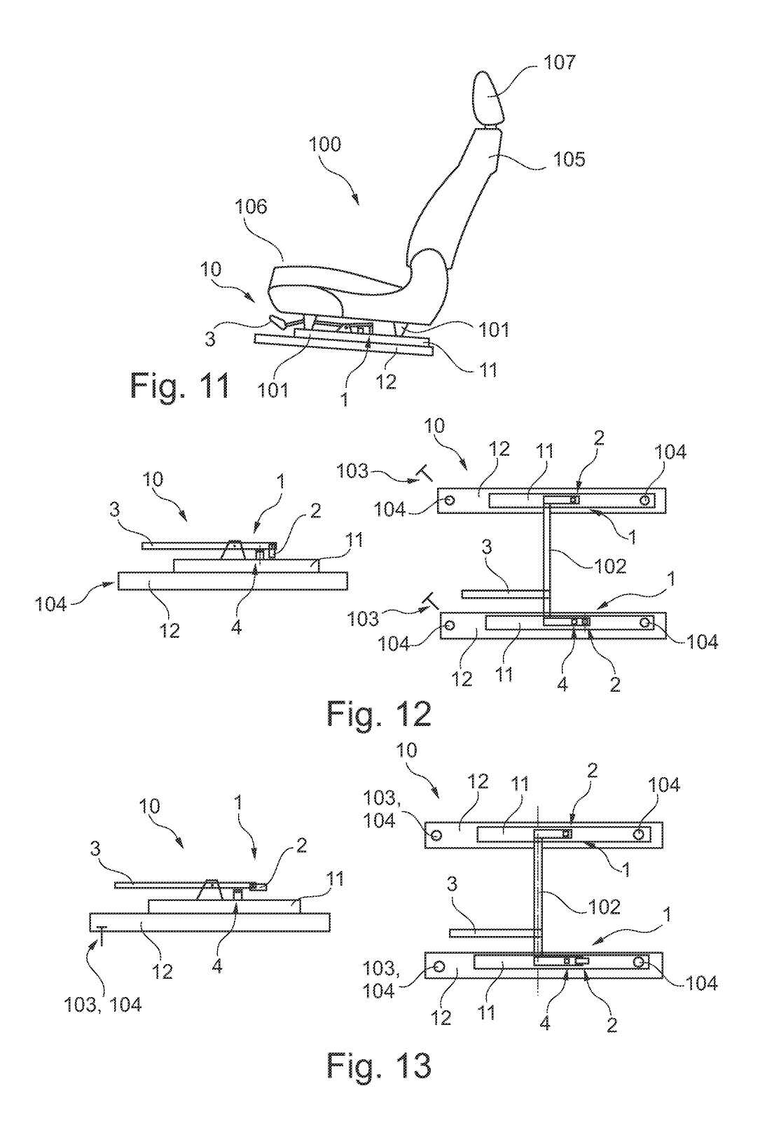

FIG. 11 shows a schematic side view of a vehicle seat 100 having a seat moving device 10 having a locking device 1. The vehicle seat 100 comprises a backrest 105 having a head support 107 and a seat part 106. The vehicle seat 100 is fastened so it is longitudinally movable on both longitudinal sides on a complementary pair of rail units 11 and 12, which can slide against one another. The longitudinal adjustment occurs in the direction of the rail units 11 and 12, i.e., forward and/or backward.

FIG. 12 to FIG. 15 show various steps of a method for installing a vehicle seat 100 in a motor vehicle, the vehicle seat 100 and the motor vehicle not being shown for the sake of clarity. The vehicle seat 100 is fastened to a floor of the motor vehicle. In the left view of FIG. 12 to FIG. 15, a schematic side view of the seat moving device 10 having the locking device 1 is shown in each case (see also FIG. 8 to FIG. 10). In the right view of FIG. 12 to FIG. 15, a schematic top view of the seat moving device 10 having the locking device 1 is shown in each case. The seat moving device 10 and the locking device 1 correspond to the already described seat moving devices 10 and locking devices 1.

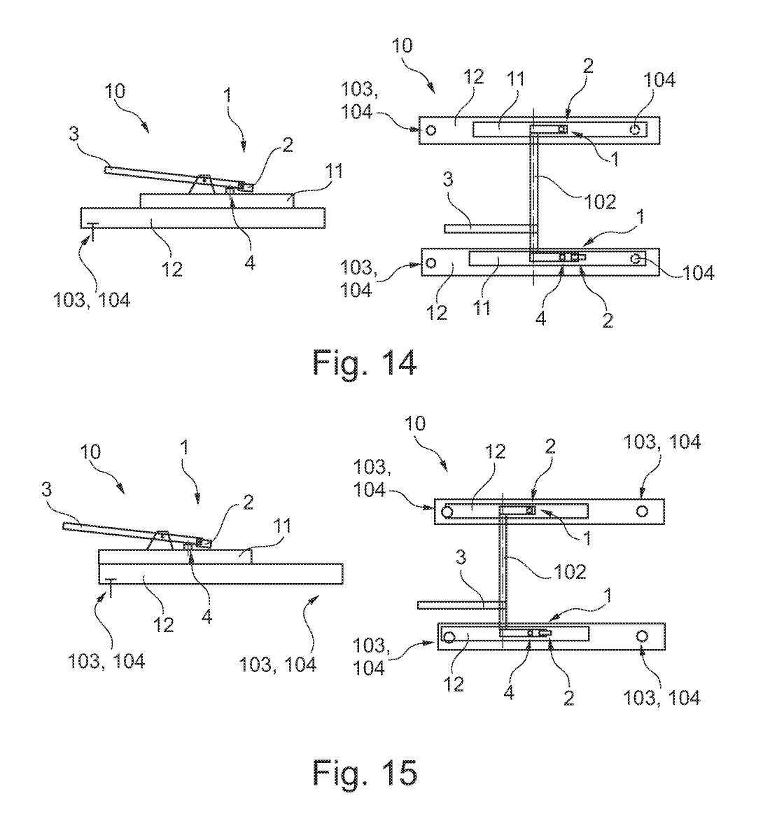

In FIG. 12, the vehicle seat 100 is moved all the way to the rear (to the right in the figure) on the vehicle-side rail unit 12, i.e., in the direction of the backrest 105 or opposite to the viewing direction of a passenger. In the exposed part of the vehicle-side rail unit 12, i.e., in the area which is not concealed by the seat-side rail unit 11, recesses 104 are shown. In FIG. 13, a fastener 103, for example, a screw, is arranged in each of the recesses 104. The recesses 104 are implemented as screw holes, for example. The actual fastening of the vehicle seat 100 on the motor vehicle is performed by means of the fastener 103. The blocking element 2 is located in the blocking position. Unintentional and/or uncontrolled movement of the vehicle seat 100 is therefore prevented. The vehicle seat 100 remains in the same position on the vehicle-side rail units 12 due to the blocking of the longitudinal movement on both sides. In particular, safe installation is possible through the blocking of the longitudinal movement of the vehicle seat 100. In FIG. 14, the blocking element 2 is shown in the release position and the actuating unit 3 is pivoted. The vehicle seat 100 is movable all the way to the front, i.e., in the viewing direction of a passenger, on the vehicle-side rail units 12 (see FIG. 15). As soon as the vehicle seat 100 is moved forward, recesses 104, which were concealed up to this point by the seat-side rail units 11, are exposed in the rear areas of the vehicle-side rail units 12. Fasteners 103 can be arranged in the recesses 104, so that the vehicle seat 100 is completely fastened in the motor vehicle. The blocking element 2 remains secured in the release position by the fixing elements.

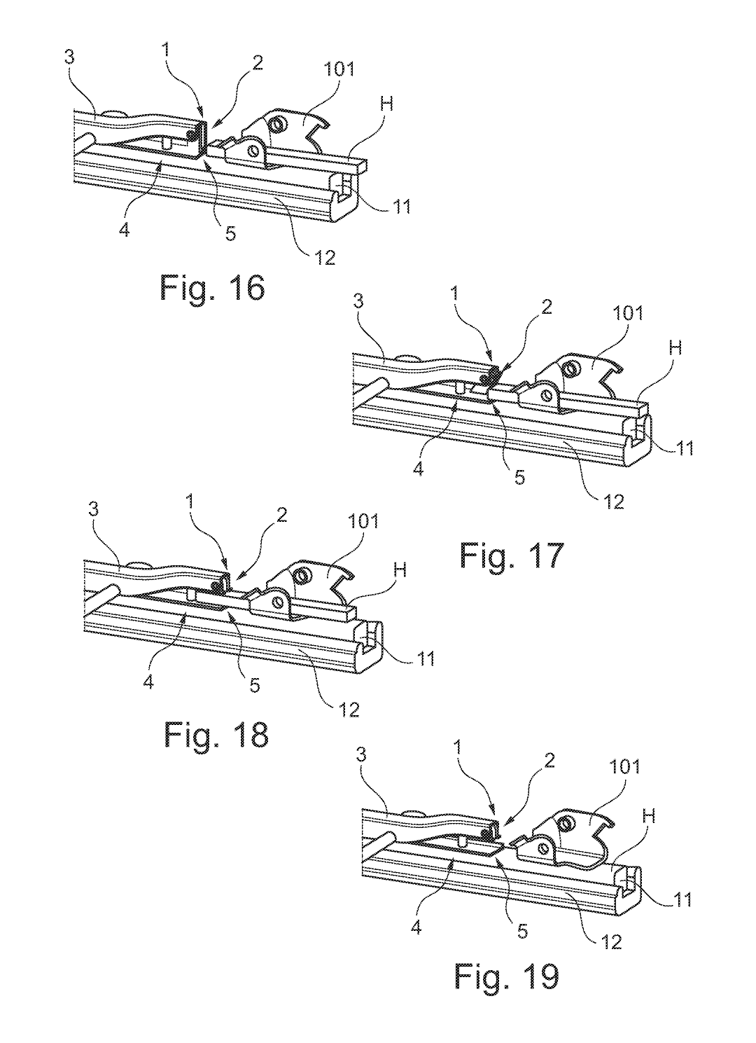

FIG. 16 to FIG. 19 each show a schematic perspective partial view of the seat moving device 10 having the locking device 1 according to FIG. 1 and an auxiliary means H. The individual components of the locking device 1 correspond to the components shown in FIG. 1. An extensive explanation of already described components is therefore omitted. The auxiliary means H is used for tool-triggered rotation, which can be actuated, of the blocking element 2 from the blocking position into the release position. The auxiliary means H is implemented as a square element like a hexagon socket. The shape of the square element approximately corresponds to the shape of the seat-side rail unit 11. In FIG. 16, the blocking element 2 is located in the blocking position and the auxiliary means H is pushed from the rear along the seat-side rail unit 11 toward the blocking element 2. The auxiliary element H engages on the lateral engagement point 5 of the blocking element 2 and rotates it into the release position, it being pushed through below the blocking element 2 (see FIG. 17 and FIG. 18). The auxiliary means H is subsequently withdrawn again (see FIG. 19). The blocking element 2 snaps into the fixing units (not shown) of the actuating unit 3, so that it does not unintentionally rotate back into the release position.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A locking device for a longitudinal movement of a seat, comprising:
an unlocking device;
an actuating unit operationally linked to the unlocking device; and
a blocking device that is configured to block the longitudinal movement.

2. The locking device according to claim 1, wherein the blocking device is coupled to the actuating unit.

3. The locking device according to claim 1, wherein the blocking device is coupled to the unlocking device.

4. The locking device according to claim 1, wherein the blocking device comprises a blocking element that is mounted for movement between an at least one blocking position and an at least one release position.

5. The locking device according to claim 3, wherein the blocking device is mounted for movement in a direction of the longitudinal movement of the seat.

6. The locking device according to claim 3, wherein the blocking device is mounted for movement transversely to the longitudinal movement of the seat.

7. The locking device according to claim 4, further comprising a fixing unit that is configured to lock the blocking device in the at least one blocking position.

8. The locking device according to claim 4, further comprising a fixing unit that is configured to lock the blocking device in the at least one release position.

9. A method for handling a motor vehicle seat that is movable in a longitudinal direction after an unlocking, comprising blocking a movement of the motor vehicle seat in order to lock the motor vehicle seat in a longitudinal position independently of the unlocking.
